(19) United States
(12) Patent Application Publication
(10) Pub. No.: US 2009/0247124 A1
(43) Pub. Date: Oct. 1, 2009

(54) PROVISIONING MOBILE DEVICES BASED ON A CARRIER PROFILE

(75) Inventors: Dallas de Atley, San Francisco, CA (US); Heiko Panther, San Francisco, CA (US); Mitchell Adler, Cupertino, CA (US); Simon Cooper, Cupertino, CA (US); Michael Brouwer, San Jose, CA (US); Matt Reda, San Jose, CA (US)

Correspondence Address: Knobbe, Martens, Olson & Bear, LLP, 2040 Main Street, Fourteenth Floor, Irvine, CA, 92614, US

(73) Assignee: APPLE INC., Cupertino, CA (US)

(21) Appl. No.: 12/397,733

(22) Filed: Mar. 4, 2009

Related U.S. Application Data
(60) Provisional application No. 61/033,733, filed on Mar. 4, 2008.

(51) Int. Cl. H04M 1/66; H04M 1/00

(52) U.S. Cl. 455/410; 455/550.1

(57) ABSTRACT

Systems and methods for provisioning computing devices are provided. Carrier provisioning profiles are distributed to computing devices via an activation service during the provisioning process. The carrier provisioning profiles specify access limitations to certain device resources which may otherwise be available to users of the device.

### CROSS REFERENCE TO RELATED APPLICATIONS

This application claims the benefit of U.S. Provisional Patent Application No. 61/033,733, filed on Mar. 4, 2008, which is hereby incorporated by reference in its entirety.

### BACKGROUND

1. Field

This application relates to provisioning of devices.

2. Description of the Related Technology

Different network carriers often have different requirements regarding how mobile computing devices can interact with their respective networks or the applications they may execute. In order to ensure that a mobile computing device operates properly and complies with network policies, it typically undergoes a provisioning process, which configures the phone via a firmware update to operate on the carrier's network. This provisioning process is also commonly referred to as bootstrapping.

However, the mobile devices often have capabilities that the carriers do not want utilized on their networks. For example, a mobile device may be designed with Bluetooth functionality, but the carrier may wish to prevent its users from taking advantage of that capability. Various applications on these devices may also need to be restricted.

One complication to performing provisioning is that some mobile devices can employ various security schemes, such as application signing to prevent malicious code, viruses, etc. For example, some mobile devices require that some or all of the code executed on the device be authorized with a digital signature by a trusted party. Unfortunately, this security mechanism can be a barrier to provisioning or can make it difficult to provision these types of devices.

### BRIEF DESCRIPTION OF THE DRAWINGS

FIG. 1 is a block diagram providing an example of a computing environment suitable for device provisioning according to one or more embodiments described herein.

FIG. 2 is a block diagram providing one example of how a computing device from FIG. 1 may be configured to utilize carrier provisioning profiles.

FIG. 3 is a more detailed view of the carrier provisioning profile shown in FIG. 2.

FIG. 4 is a more detailed view of the code signer identifier data shown in FIG. 3.

FIG. 5 is more detailed view of the device identifier data shown in FIG. 3.

FIG. 6 is a more detailed view of the entitlement data from FIG. 3.

FIG. 7 is a flowchart which provides an illustration of a process by which a carrier may request a provisioning profile from a trusted authority.

FIG. 8 is a flowchart illustrating one example of how policies defined in a carrier provisioning profile may be delivered to a device.

FIG. 9 is a flowchart illustrating one example of how a carrier provisioning profile may be enforced on a device.

FIG. 10 is a flowchart illustrating an alternate embodiment in which carrier policies may restrict code otherwise trusted by the device operating system.

FIG. 11A illustrates an example mobile device.

FIG. 11B illustrates another example of configurable top-level graphical user interface of a device.

FIG. 12 is a block diagram of an example implementation of a mobile device.

### DETAILED DESCRIPTION

Various embodiments described herein provide systems and methods for provisioning computing devices, for example, on carrier networks. In some instances, a computing device may be configured to require that some or all of the code be digitally signed by a trusted party and verified in order to be executed on the computing device. Systems and methods are disclosed herein, which can allow carriers to provision computing devices which encourage or require that code executed on the device be authorized by a trusted party. Using the systems and methods described herein, carriers may thus be able to effectively provision those computing devices to control access to facilities and resources on the devices in such a way that trusted applications also comply with the network policies of the carrier.

In some embodiments, in order to gain authority for provisioning devices, a carrier (or its representative) may send requests to a trusted authority. This request may specify types of access and functionality that the carrier would like devices to have while operating on its network. The trusted authority may create for the carrier a carrier provisioning profile, which reflects the carrier's desired network policies for those devices on the carrier's network or allows the carrier to modify the device appropriately. An access profile and a policy process may also be provided and installed onto the specified devices to enforce this provisioning profile.

When code executes on the device, the policy process may check entitlements specified in the carrier provisioning profile to determine whether the code execution request may be granted. If the carrier provisioning profile includes the necessary entitlements, the code may be permitted to access the data and/or system functionality requested. If the carrier provisioning profile does not include the necessary entitlements, the ability of the code to access certain data and/or functionality on the device may be restricted.

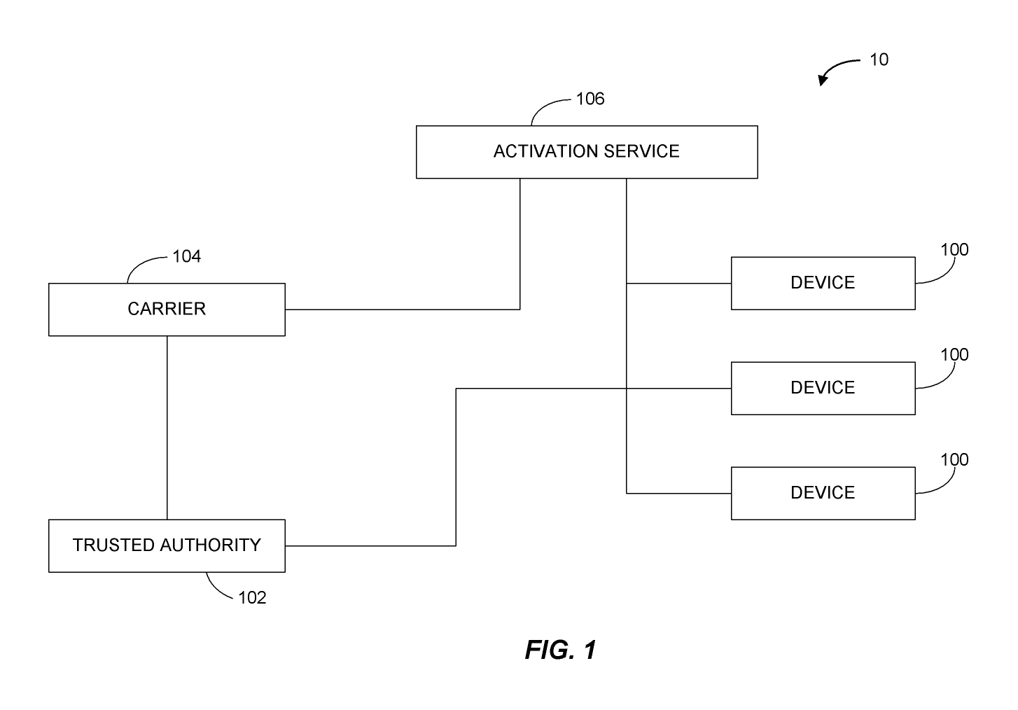

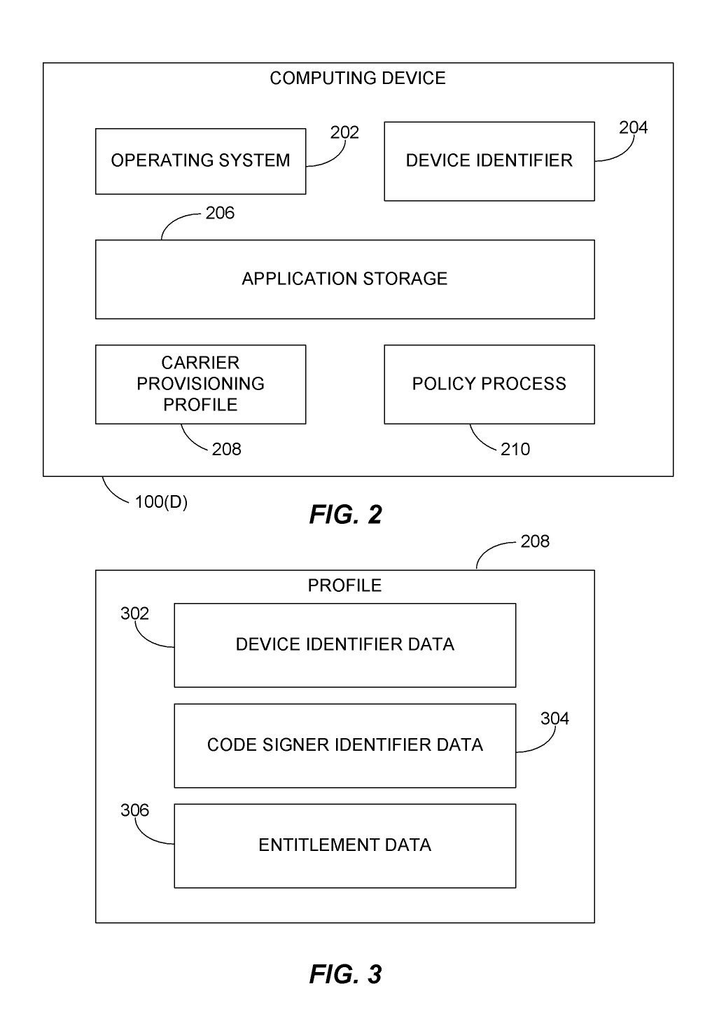

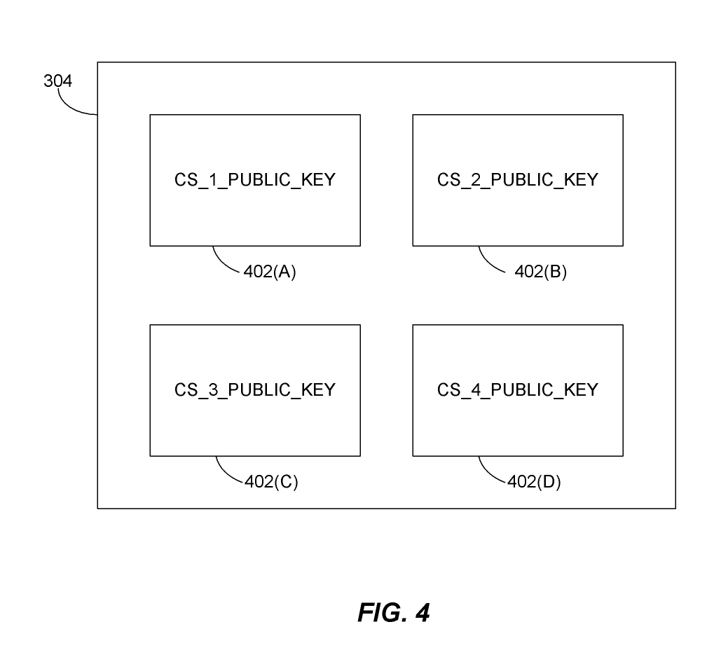

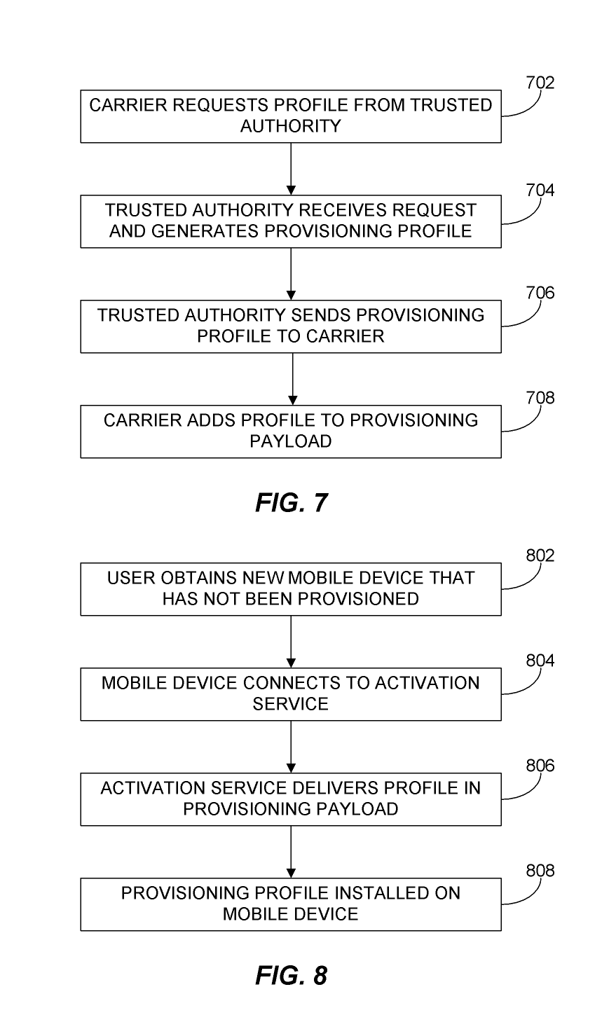

In order to help explain the embodiments of these and other concepts, FIGS. 1-10 are provided in this description. FIG. 1 shows an example of a computing environment suitable for device provisioning. FIGS. 2-3 shows a device being configured with a carrier provisioning profile and an example of a provisioning profile. FIGS. 4-6 show examples of the data that may be included in the provisioning profile, such as code signer identifier data, device identifier data, and entitlement data. FIGS. 7-10 are then provide to illustrate various process flows related to obtaining, installing, and enforcing carrier provisioning profiles. These figures will now be further described below beginning with reference to FIG. 1.

FIG. 1 is an example of an environment suitable for practicing various embodiments described herein. In the system shown, computing devices 100 may be provided or controlled from trusted authority 102 and may utilize a network operated by carrier 104. These entities and components will now be further described.

Computing devices 100 may be mobile computing devices, such as mobile telephones, mobile smart-phones, or some other type of mobile device. Computing devices 100 may be configured to run an operating system that requires some or all of the code executing be approved by trusted authority 102. Thus, if software is delivered in an unauthorized state to computing devices 100, the devices may be unable to fully execute the code instructions included in the software because they have not been authorized.

Although the present disclosure relates to provisioning of mobile devices, computing devices 100 may be any number of different types of computing devices, including desktop computers, laptop computers, handheld computers, personal digital assistant (PDA) devices, mobile telephone devices, media play device, and the like.

When a user wishes to operate their computing device 100 on the network of carrier 104, that device 100 may need to be provisioned or activated so that it is able to operate on the network. In one or more embodiments, activation service 106 is used to perform this provisioning process. Activation service 106 may be implemented as one or more servers on a network, such as the Internet that transmit data to computing device 100, which is then used to configure device 100 to operate on the network of carrier 104.

The data transmitted by activation service 106 may take the form of what can be referred to as a carrier provisioning profile. The carrier provisioning profile may specify a policy and entitlements of how device 100 may use facilities and/or resources on device 100, and how it may interact with the network services operated by carrier 104.

Trusted authority 102 may be any person or organization, which is able to authorize code so that it can run on a computing device 100. Of course, a particular device 100 may have more than one trusted authority 102. In some embodiments, the trusted authority 102 may be an organization and/or entity which exercises control over the operating system and security model of the computing device 100.

As used herein, carrier 104 may be an entity that provides network access to computing devices 100. Well known examples of carriers 104 are mobile telephone service providers such as Verizon, AT&T, T-Mobile, Sprint, and the like.

As noted, activation service 106 may be the systems and processes used to provision devices 100. Activation service 106 may include one or more network applications and servers operating on network-connected computing devices that are configured to transmit provisioning data over a network.

In some embodiments, activation service 106 may transmit provisioning to a local application running on a personal computer. One or more of devices 100 may be coupled to the personal computer to receive the provisioning data via a provisioning application on the personal computer. Alternatively, computing device 100 may be shipped with basic functionality, which allows device 100 to connect to the carrier network to receive the provisioning data from activation service 106. Activation service 106 may also transmit provisioning data directly to devices 100, for example, via the network of carrier 104. Provisioning data may also be installed from a computer readable medium or on a storage device coupled to a server. In some embodiments, computing devices 100 may also, in addition to receiving carrier provisioning profiles, include development, test, and other types of software such as profiling software as part of a standard distribution installed on developer computing devices 100, as part of a pre-provisioning process, or at any other time. In some embodiments, computing devices 100 are pre-provisioned with such additional software. In other embodiments, this additional software may be installed on the device with, or in conjunction with, the carrier access profile.

FIG. 2 is a block diagram providing one example of how computing device 100 may be configured with carrier provisioning profile 208 to govern the behavior of device 100 and interaction with the network of carrier 104. The computing device 100 can typically include operating system 202. Operating system 202 may be any of the well-known operating system such as MacOS, Windows, Linux, Unix, Symbian, or the like.

As discussed briefly above, in some embodiments, operating system 202 may be configured to require that code executed on device 100 be authorized prior allowing its execution. The authorization may take the form of a digital signature by trusted authority 102. In some embodiments, computing device 100 utilizes a certificate from trusted authority 102, which may be used to verify the source and integrity of the digitally signed computer code.

In the embodiments, a digital signature may be created by performing a hash function on the software in order to create a message digest. The message digest may be encrypted using a private encryption key associated with trusted authority 102. The resulting digital signature may then be appended to the software 106. In some embodiments, incremental code signing may be used. The hash value may be a hash value generated for all or a particular portion of the software. For example, in some embodiments, the software is divided into one or more units such as one or more pages. A hash value is generated for each unit or page of the software. The digest for the software in such embodiments includes a hash value that is generated for an array or table of the hash values of each code or page. The message digest may be then encrypted using a private encryption key associated with trusted authority 102. In one embodiment, the well known SHA-1 function may be used to generate the message digest. The encrypted message digest (also referred to as the signature) may be then appended to the one or more of the software modules 206.

In some embodiments, when a request is made on device 100 to execute software code, operating system 202 may process the request by verifying the source and integrity of the software code by validating the digital signature. If the source of the code was signed by trusted authority 102, and the integrity of the code has not been compromised, operating system 202 may allow the code to run on the computing device 100.

Computing device 100 also may include device identifier 204. Device identifier 204 may take various forms. In one embodiment, device identifier 204 may be a serial number that uniquely identifies computing device 100. In other embodiments, device identifier 204 may be a unique identifier generated by operating system 202. Computing device 100 may also include software storage 206. Software storage 206 may be typically a volatile and/or non-volatile memory on device 100 where software may be stored for use by operating system 202 of device 100.

As noted above, computing device 100 may also have a carrier provisioning profile 208 installed. Carrier provisioning profile 208 may be typically created by trusted authority 102 at the behest of carrier 104. Trusted authority may generate provisioning profile 208 and provide it to carrier 104 for delivery to device 100 via activation service 106 (or some other installation mechanism available to carrier 104). Trusted authority 102 may digitally sign carrier provisioning profile 208 so that device 100 knows to allow it to be installed without restriction.

Carrier provisioning profile 208 may be a set of data that indicates what types of applications and services are authorized by carrier 104 to be executed or provided on device 100. In some embodiments, carrier provisioning profile 208 may also specify that software code signed by certain digital certificates can access functionality of device that may be otherwise unavailable to the user on the network of carrier 104. For example, in some instances, carrier 104 may have its own digital certificates installed on devices 100, which allow it to also digitally sign some or all of the code.

For example, a carrier 104 may wish to provide an enhanced service which utilizes the global positioning system (GPS) functionality in a mobile device. Carrier 104 may wish to charge a premium for this service, so it may configure carrier provisioning profile 208 to disallow third party applications from accessing the GPS functionality in device 100, and instead only allow applications digitally signed by carrier 104 (or another entity affiliated with carrier 104) to access the GPS services in device 100.

In some embodiments, carrier provisioning profile 208 may operate in conjunction with policy process 210. Policy process 210 may take the form of a daemon process running in a user memory space of operating system 202. Alternatively, policy process 210 may be a component of operating system 202. Policy process 210 may also be a daemon process running in protected space in the system memory. In some embodiments, policy process 210 may be delivered and installed on computing devices 100 along with carrier provisioning profile 208 by activation service 106.

Policy process 210 may run as a system service and may alternatively be referred to herein as a policy service 210. As another alternative, policy process 210 may be included with device 100 as part of its base operating system 202 as originally shipped. In still other implementations, policy process 210 may be added to device via an operating system update process.

Policy process 210 may be typically used to enforce policies specified in carrier provisioning profile 208. In certain embodiments, policy process 210 may be configured to detect code execution requests and determine whether the request should be permitted. For example, when a request to execute code is detected, policy process 210 may be configured to check the digital signature of the code to ensure that it is valid. If the digital signature is not from a trusted authority 102 or some other authorized entity, policy process 210 may access carrier provisioning profile 208 on device 100 to determine if the signature is by anotherparty authorized in profile 208 to digitally sign code. Policy service 210 may further enforce specific entitlements (discussed below in additional detail) specified in carrier provisioning profile 208.

FIG. 3 is a more detailed view of carrier provisioning profile 208. As noted above, carrier provisioning profile 208 may be a set of data stored in the memory of device 100, which indicates provides information to policy service 210 about what types of operations and resources may be accessed by code authorized to execute on device 100. Provisioning profile 208 may include device identifier data 302, code signer identifier data 304, and entitlement data 306.

Device identifier data 302 specifies one or more device identifiers 204 to which carrier provisioning profile 208 applies. Device identifier 204 may be inserted into carrier provisioning profile 208 by activation service 106 when device 100 requests activation on the network of carrier 104. In embodiments where devices 100 are mobile telephone devices, device identifier data 302 may include an array of mobile telephone device serial numbers. Alternatively, device identifier data 302 may include a wildcard value which indicates that profile 208 applies to all devices 100 having device identifiers 204 that match the wildcard value.

Carrier provisioning profile 208 may further include code signer identifier data 304, which may include an identifying data associated with carrier 104. Code signer identifier data 304 may further include data indicative of other entities that may be permitted to sign code, which are authorized by profile to run on device 100. In some embodiments, code signer identifier data 304 may simply include a wildcard value. Including a wildcard value indicates that the entitlements (discussed below) specified by profile 208 can apply to all code executed on device regardless of the digital signature applied to the code.

Code signer identifier data 304 may take various forms. In some embodiments, code signer identifier data 304 may be public keys associated with carrier 104 or possibly third party software distributors covered by carrier provisioning profile 208. Other types of identifiers may be used.

Carrier provisioning profile 208 also includes entitlement data 306. Entitlement data 306 may include data which indicates the types of operations that are allowed for software 106 signed by developers identified in developer identifier data 304 on devices 100 specified in device identifier data 302.

FIG. 4 is a more detailed block diagram of code signer identifier data 304. As discussed above, a single carrier provisioning profile 208 may specify more than one code signer as being authorized to digitally sign code. In the example provided in FIG. 4, four code signer identifiers 402(A)-402(D) are specified, with four different public keys stored in code signer identifier data 304. First code signer identifier 402(a) may be carrier 104. The remaining code signer identifiers 402(B)-402(D) may be third parties who have agreements with carrier 104, for example, to develop software that is allowed to run on the carrier's network. In some embodiments, the code signer identifier data 304 may be stored in an array data structure stored within carrier provisioning profile 208. Other types of data structures may be used, however.

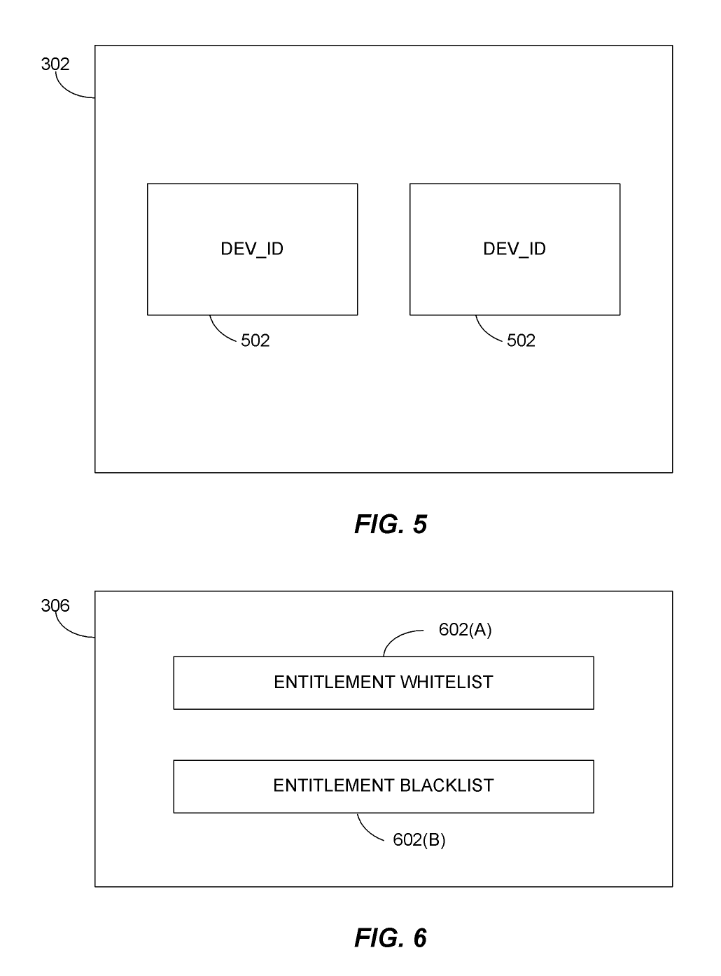

FIG. 5 is a more detailed block diagram of device identifier data 302. Device identifier data 302 for a carrier provisioning profile 208 may include one or more device identifiers 204. In the example provided in FIG. 5, two different device identifiers 502 are included in profile 208. Various types of device identifying data may be utilized. In some embodiments, wild card characters (or some similar technique) may be used to specify that carrier provisioning profile applies to all devices on which it may be installed. In these instances, software signed by one or more of entities identified in developer identifier data 302 could be authorized to run on any device 100 upon which carrier provisioning profile 208 has been installed.

FIG. 6 provides a more detailed view of an example of the types of data that may be included in entitlement data 306. As discussed above, carrier provisioning profile 208 may specify a policy on how to use facilities and/or resources both on device 100 and the network of carrier 104. For example, entitlement data 306 may take the form of predefined Boolean variables, which are indicative of various entitlements or restrictions.

In some embodiments, entitlement data 306 may be listed as sets of “white list” entitlements 602(A). White list entitlements 602(A) may include specified entitlements such as Acces_To_Edge_Allowed, Access_To_UMTS_Allowed, Access_To_Bluetooth, and the like. entitlement data may also include a blacklist of entitlements entitlement 602(B). A blacklist of entitlements may call out specific functionality that may be restricted or unavailable to device 100 when configured to operate on carrier's network.

Referring now to FIG. 7, a flowchart provides a general illustration of a process by which carrier 104 may request a provisioning profile from a trusted authority 102. The process may begin at block 702, where carrier 104 requests a provisioning profile from trusted authority 102. Typically, the request may specify device 100 resources that should be made available and/or device 100 resources that are to be restricted. The request may further include identity data to include in the profile 208. For example, the request may include a range of device serial numbers to be included in device 100 identifier data 302 of the profile. The request may also include one or more code signer identities 304 to associate with profile 208.

In some embodiments, the request may be transmitted to trusted authority 102 via provisioning profile application form provided via a website of the trusted authority. Trusted authority 102 may receive the request from carrier 104 and generate a provisioning profile 208 in accordance with the request.

Once trusted authority 102 has generated profile 208, it may transmit provisioning profile 208 to carrier 104. In some embodiments, profile 208 may be transmitted via a secure network connection to carrier 104. Once carrier 104 has received profile 208, carrier 104 then may add profile 208 into a provisioning payload at activation service 106. Although this particular embodiment provides for carrier 104 inserting profile 208 into an activation service payload, a skilled artisan may readily appreciate that in certain embodiments, trusted authority 102 may manage activation service 106 and therefore would provide carrier access profile 208 to activation service 106 without first transmitting it to carrier 104.

Once carrier provisioning profile 208 has been provided to activation service 106, it may then be delivered to carrier's 104 customers. FIG. 8 is a flowchart illustrating one example of how profile 208 may be delivered to a device 100. The process may begin at block 802, where a customer of carrier 104 may obtain a computing device 100 (such as a mobile phone device, for example), which has not been provisioned to operating on the network of carrier 104. As noted above, device 100 may need to be provisioned in order to operate on a carrier network. In order to provision device 100, the user may then connect device 100 to the activation service 106. As noted previously, activation service 106 may be carried out using various provisioning techniques.

At block 804, device 100 may be connected to activation service 106. As discussed above, device 100 may connect to activation service via a network connection (such as Bluetooth, for example), or it may connect to a local application, which forms a portion of activation service 106 via a tethered connection (such as USB or Firewire).

Once device 100 has connected to activation service 106, the process may move to block 806 where activation service 106 retrieves the appropriate profile 208 for device 100 and transmits it to device 100 in a provisioning payload. Once the payload as been transmitted, device 100 then installs carrier provisioning profile 208 at block 808. Once carrier provisioning profile 208 has been installed on device 100, it may then operate in accordance with the policies specified in profile 208.

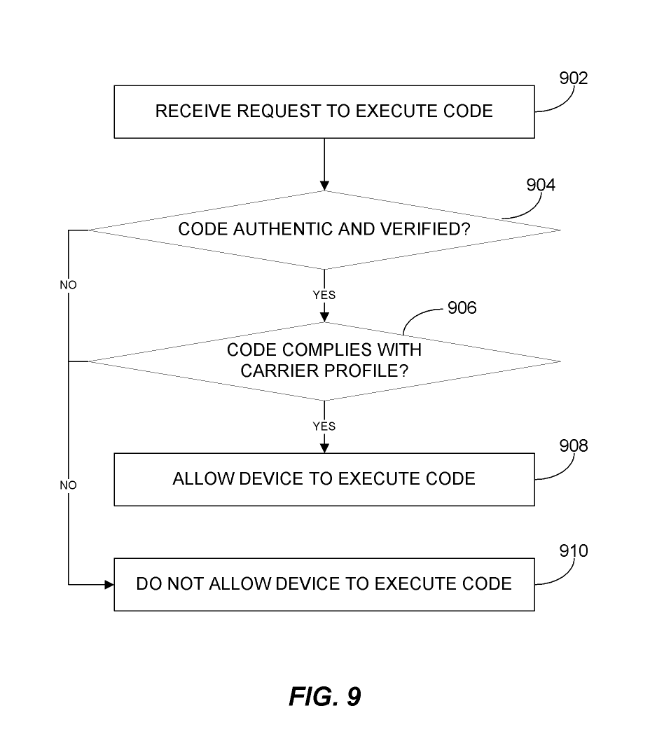

Referring now to FIG. 9, an example is provided of how code executed on device 100 may be policed by policy service 210 to ensure that it complies with carrier provisioning profile 208 delivered by activation service 106. The process may begin at block 902, where device operating system 202 receives a request to execute code on device 100. This code request may be made by an application, or it may even be made by a trusted process within the kernel of operating system 202.

Upon receiving the request, the process then may move to decision block 904, where the code may be checked to make sure it is authentic and verified. As part of this decision process, policy service 210 (or possibly some other part of operating system 202) may check to determine if the code has been digitally signed. If the code has not been digitally signed, the request to execute the code fails and the process jumps to block 910 where the code execution may be blocked on device 100. If the code is digitally signed and verified as being authentic, the process then may move to decision block 906, where the system checks to determine whether the software code complies with carrier provisioning profile 208.

As part of this determination, policy service 210 may determine what device resources and/or data are requested by the code. If those resources and/or data are, for example, in entitlement blacklist 602(B), the code does not comply with provisioning profile 208. Similarly, if provisioning profile 208 may be configured with a white list 602(A) of entitlements, policy service 210 may check to see if the system resources and/or data are provided in the profile white list.

If not, the code may not be authorized by provisioning profile 208. Policy service 210 may further consider the code signer in determining whether code request complies with access profile. If the code is not in compliance with the code signer identifier data 302 in provisioning profile 208, the process may move to block 910, and the code execution may be blocked. In some embodiments, a message may be generated on the display of device 100 which indicates that code was blocked. If, however, policy service 210 finds that the code complies with provisioning profile 208, the code may be permitted to run on device 100.

As discussed above, computing devices 100 may be configured to require that code executed on device be authorized by trusted authority 102 either by digitally signing the code or by some other authorization routine. In some mobile device platforms, code signed by trusted authority 102 may be fully trusted by operating system 202 and is therefore generally permitted to execute on device 100 without restriction. A potential conflict may arise in a situation where device 100 ships with a trusted application which utilizes resources that carrier 104 does not wish to allow. In order to avoid this problem, policy service 210 may be configured to prioritize the carrier provisioning profile entitlements.

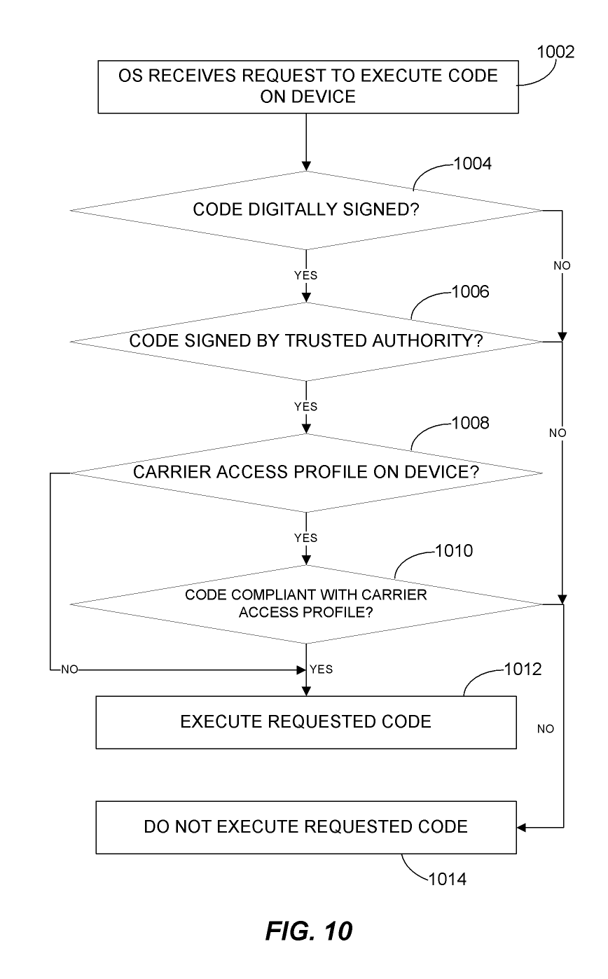

With reference to FIG. 10, a flowchart provides one example of how the carrier access profile 210 may be enforced to restrict the access of trusted applications to resources and/or data on device 100. The process may begin at block 1002, where operating system 202 of device 100 receives a request to execute code. Next, the process may move to decision block 1004, where the code may be checked for a digital signature. If the code is found not to be digitally signed, the process jumps to block 1014, and the code execution may be blocked on device 100. If, however, the code is digitally signed, the process may move to decision block 1006, where it may be determined whether the digital signature is by trusted authority 102. If the code is not signed by a trusted authority 102, the process may move to block 1014, and the execution of the code may be blocked. If the code has been signed by a trusted authority 102, the process instead may move to decision block 1008.

It should be noted that in a platform configuration in which code signed by a trusted authority may be normally trusted by operating system, a finding at decision block 1006 that the code has been signed by trusted authority 102 would ordinarily mean that the code can be executed by operating system 202 without further review. However, in this particular embodiment, further review may be required and the process may move to decision block 1008, where the system determines if a carrier provisioning profile 208 exists on device 100. If no profile 208 is found on device 100, then the process may move to block 1012 and the code may be executed without restriction on device 100 because it has already been verified as trusted in block 1006 above. If carrier provisioning profile 208 exists on device, however, the process may move to decision block 1010, and the code may be checked against entitlements 602 in provisioning profile 208.

If, at decision block 1010, it is determined that the code complies with carrier provisioning profile 208, the process may move to block 1012, and the code execution may be allowed on device. If the code, however, does not comply with entitlements 602 in provisioning profile, the process jumps instead to block 1014, and execution of the code may be blocked. As noted above, when code execution has been blocked, device 100 may be configured to display a message to the user indicating that code execution has been prevented by the carrier policies.

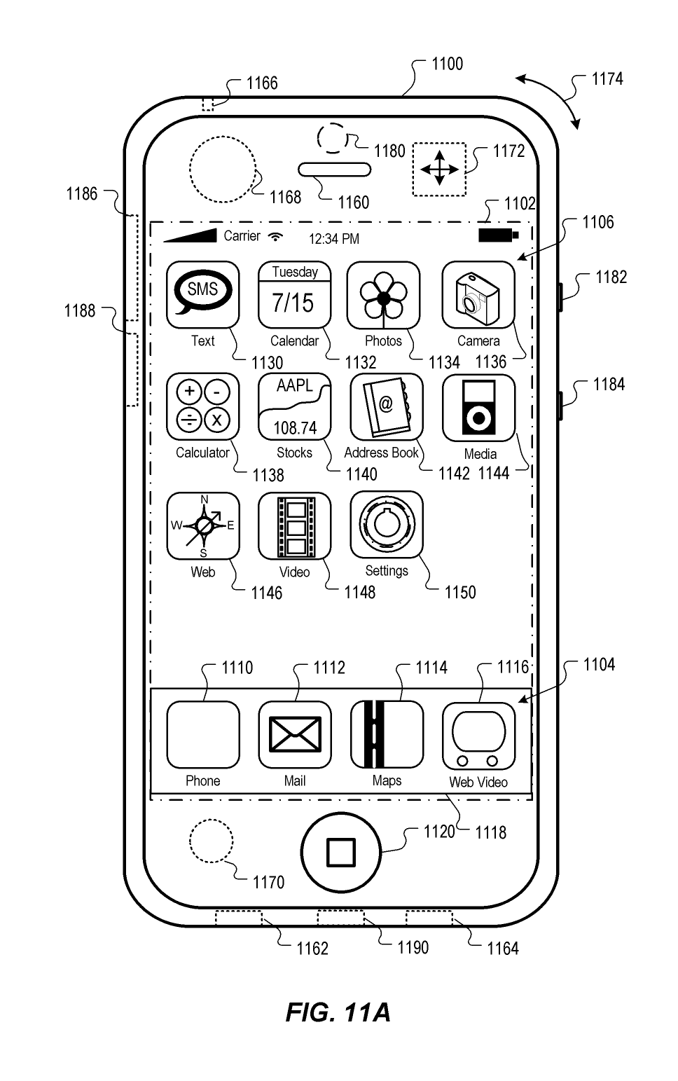

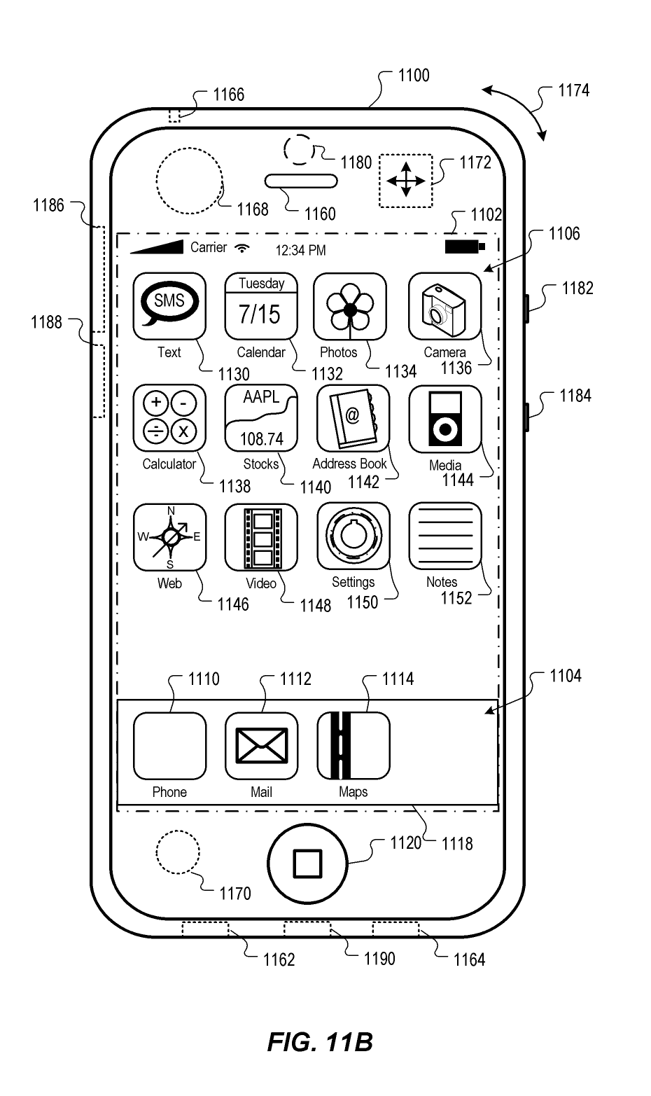

FIG. 11A illustrates an example mobile device 1100. The mobile device 1100 can be, for example, a handheld computer, a personal digital assistant, a cellular telephone, a network appliance, a camera, a smart phone, an enhanced general packet radio service (EGPRS) mobile phone, a network base station, a media player, a navigation device, an email device, a game console, or a combination of any two or more of these data processing devices or other data processing devices.

### Mobile Device Overview

In some implementations, the mobile device 1100 includes a touch-sensitive display 1102. The touch-sensitive display 1102 can be implemented with liquid crystal display (LCD) technology, light emitting polymer display (LPD) technology, or some other display technology. The touch sensitive display 1102 can be sensitive to haptic and/or tactile contact with a user.

In some implementations, the touch-sensitive display 1102 can comprise a multi-touch-sensitive display 1102. A multi-touch-sensitive display 1102 can, for example, process multiple simultaneous touch points, including processing data related to the pressure, degree, and/or position of each touch point. Such processing facilitates gestures and interactions with multiple fingers, chording, and other interactions. Other touch-sensitive display technologies can also be used, e.g., a display in which contact is made using a stylus or other pointing device. Some examples of multi-touch-sensitive display technology are described in U.S. Pat. Nos. 6,323,846, 6,570,557, 6,677,932, and 6,888,536, each of which is incorporated by reference herein in its entirety.

In some implementations, the mobile device 1100 can display one or more graphical user interfaces on the touch-sensitive display 1102 for providing the user access to various system objects and for conveying information to the user. In some implementations, the graphical user interface can include one or more display objects 1104, 1106. In the example shown, the display objects 1104, 1106, are graphic representations of system objects. Some examples of system objects include device functions, applications, windows, files, alerts, events, or other identifiable system objects.

### Example Mobile Device Functionality

In some implementations, the mobile device 1100 can implement multiple device functionalities, such as a telephony device, as indicated by a Phone object 1110; an e-mail device, as indicated by the Mail object 1112; a map devices, as indicated by the Maps object 1111; a Wi-Fi base station device (not shown); and a network video transmission and display device, as indicated by the Web Video object 1116. In some implementations, particular display objects 1104, e.g., the Phone object 1110, the Mail object 1112, the Maps object 1114, and the Web Video object 1116, can be displayed in a menu bar 1118. In some implementations device functionalities can be accessed from a top-level graphical user interface, such as the graphical user interface illustrated in FIG. 11A. Touching one of the objects 1110, 1112, 1114, or 1116 can, for example, invoke a corresponding functionality.

In some implementations, the mobile device 1100 can implement a network distribution functionality. For example, the functionality can enable the user to take the mobile device 1100 and provide access to its associated network while traveling. In particular, the mobile device 1100 can extend Internet access (e.g., Wi-Fi) to other wireless devices in the vicinity. For example, mobile device 1100 can be configured as a base station for one or more devices. As such, mobile device 1100 can grant or deny network access to other wireless devices.

In some implementations, upon invocation of a device functionality, the graphical user interface of the mobile device 1100 changes, or is augmented or replaced with another user interface or user interface elements, to facilitate user access to particular functions associated with the corresponding device functionality. For example, in response to a user touching the Phone object 1110, the graphical user interface of the touch-sensitive display 1102 may present display objects related to various phone functions; likewise, touching of the Mail object 1112 may cause the graphical user interface to present display objects related to various e-mail functions; touching the Maps object 1114 may cause the graphical user interface to present display objects related to various maps functions; and touching the Web Video object 1116 may cause the graphical user interface to present display objects related to various web video functions.

In some implementations, the top-level graphical user interface environment or state of FIG. 11A can be restored by pressing a button 1120 located near the bottom of the mobile device 1100. In some implementations, each corresponding device functionality may have corresponding “home” display objects displayed on the touch-sensitive display 1102, and the graphical user interface environment of FIG. 11A can be restored by pressing the “home” display object.

In some implementations, the top-level graphical user interface can include additional display objects 1106, such as a short messaging service (SMS) object 1130, a Calendar object 1132, a Photos object 1134, a Camera object 1136, a Calculator object 1138, a Stocks object 1140, a Address Book object 1142, a Media object 1144, a Web object 1146, a Video object 1148, a Settings object 1150, and a Notes object (not shown). Touching the SMS display object 1130 can, for example, invoke an SMS messaging environment and supporting functionality; likewise, each selection of a display object 1132, 1134, 1136, 1138, 1140, 1142, 1144, 1146, 1148, and 1150 can invoke a corresponding object environment and functionality.

Additional and/or different display objects can also be displayed in the graphical user interface of FIG. 11A. For example, if the device 1100 is functioning as a base station for other devices, one or more “connection” objects may appear in the graphical user interface to indicate the connection. In some implementations, the display objects 1106 can be configured by a user, e.g., a user may specify which display objects 1106 are displayed, and/or may download additional applications or other software that provides other functionalities and corresponding display objects.

In some implementations, the mobile device 1100 can include one or more input/output (I/O) devices and/or sensor devices. For example, a speaker 1160 and a microphone 1162 can be included to facilitate voice-enabled functionalities, such as phone and voice mail functions. In some implementations, an up/down button 1184 for volume control of the speaker 1160 and the microphone 1162 can be included. The mobile device 1100 can also include an on/off button 1182 for a ring indicator of incoming phone calls. In some implementations, a loud speaker 1164 can be included to facilitate hands-free voice functionalities, such as speaker phone functions. An audio jack 1166 can also be included for use of headphones and/or a microphone.

In some implementations, a proximity sensor 1168 can be included to facilitate the detection of the user positioning the mobile device 1100 proximate to the user's ear and, in response, to disengage the touch-sensitive display 1102 to prevent accidental function invocations. In some implementations, the touch-sensitive display 1102 can be turned off to conserve additional power when the mobile device 1100 is proximate to the user's ear.

Other sensors can also be used. For example, in some implementations, an ambient light sensor 1170 can be utilized to facilitate adjusting the brightness of the touch-sensitive display 1102. In some implementations, an accelerometer 1172 can be utilized to detect movement of the mobile device 1100, as indicated by the directional arrow 1174. Accordingly, display objects and/or media can be presented according to a detected orientation, e.g., portrait or landscape. In some implementations, the mobile device 1100 may include circuitry and sensors for supporting a location determining capability, such as that provided by the global positioning system (GPS) or other positioning systems (e.g., systems using Wi-Fi access points, television signals, cellular grids, Uniform Resource Locators (URLs)). In some implementations, a positioning system (e.g., a GPS receiver) can be integrated into the mobile device 1100 or provided as a separate device that can be coupled to the mobile device 1100 through an interface (e.g., port device 1190) to provide access to location-based services.

In some implementations, a port device 1190, e.g., a Universal Serial Bus (USB) port, or a docking port, or some other wired port connection, can be included. The port device 1190 can, for example, be utilized to establish a wired connection to other computing devices, such as other communication devices 1100, network access devices, a personal computer, a printer, a display screen, or other processing devices capable of receiving and/or transmitting data. In some implementations, the port device 1190 allows the mobile device 1100 to synchronize with a host device using one or more protocols, such as, for example, the TCP/IP, HTTP, UDP and any other known protocol.

The mobile device 1100 can also include a camera lens and sensor 1180. In some implementations, the camera lens and sensor 1180 can be located on the back surface of the mobile device 1100. The camera can capture still images and/or video.

The mobile device 1100 can also include one or more wireless communication subsystems, such as an 802.11b/g communication device 1186, and/or a Bluetooth™ communication device 1188. Other communication protocols can also be supported, including other 802.x communication protocols (e.g., WiMax, Wi-Fi, 3G), code division multiple access (CDMA), global system for mobile communications (GSM), Enhanced Data GSM Environment (EDGE), etc.

### Example Configurable Top-Level Graphical User Interface

FIG. 11B illustrates another example of configurable top-level graphical user interface of device 1100. The device 1100 can be configured to display a different set of display objects.

In some implementations, each of one or more system objects of device 1100 has a set of system object attributes associated with it; and one of the attributes determines whether a display object for the system object will be rendered in the top-level graphical user interface. This attribute can be set by the system automatically, or by a user through certain programs or system functionalities as described below. FIG. 11B shows an example of how the Notes object 1152 (not shown in FIG. 11A) is added to and the Web Video object 1116 is removed from the top graphical user interface of device 1100 (e.g. such as when the attributes of the Notes system object and the Web Video system object are modified).

### Example Mobile Device Architecture

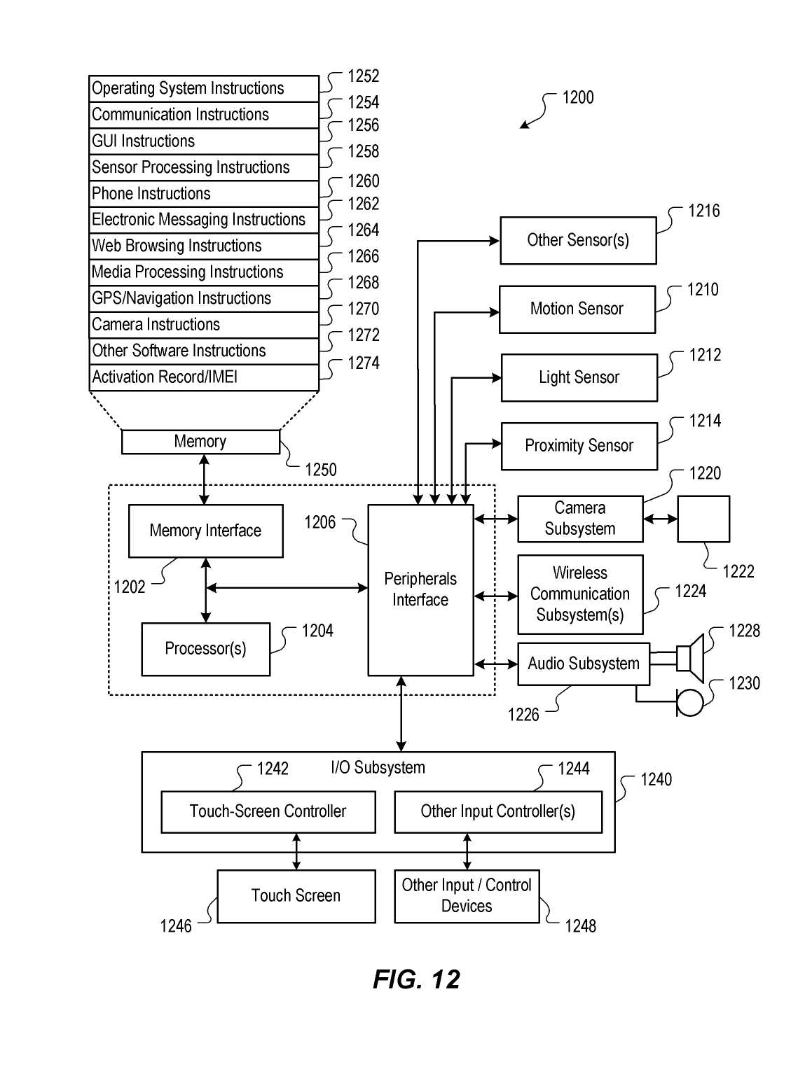

FIG. 12 is a block diagram 1200 of an example implementation of a mobile device (e.g., mobile device 1100). The mobile device can include a memory interface 1202, one or more data processors, image processors and/or central processing units 1204, and a peripherals interface 1206. The memory interface 1202, the one or more processors 1204 and/or the peripherals interface 1206 can be separate components or can be integrated in one or more integrated circuits. The various components in the mobile device can be coupled by one or more communication buses or signal lines.

Sensors, devices, and subsystems can be coupled to the peripherals interface 1206 to facilitate multiple functionalities. For example, a motion sensor 1210, a light sensor 1212, and a proximity sensor 1211 can be coupled to the peripherals interface 1206 to facilitate the orientation, lighting, and proximity functions described with respect to FIG. 11A. Other sensors 1216 can also be connected to the peripherals interface 1206, such as a positioning system (e.g., GPS receiver), a temperature sensor, a biometric sensor, or other sensing device, to facilitate related functionalities.

A camera subsystem 1220 and an optical sensor 1222, e.g., a charged coupled device (CCD) or a complementary metal-oxide semiconductor (CMOS) optical sensor, can be utilized to facilitate camera functions, such as recording photographs and video clips.

Communication functions can be facilitated through one or more wireless communication subsystems 1224, which can include radio frequency receivers and transmitters and/or optical (e.g., infrared) receivers and transmitters. The specific design and implementation of the communication subsystem 1224 can depend on the communication network(s) over which the mobile device is intended to operate. For example, a mobile device can include communication subsystems 1224 designed to operate over a GSM network, a GPRS network, an EDGE network, a Wi-Fi or WiMax network, and a Bluetooth™ network. In particular, the wireless communication subsystems 1224 may include hosting protocols such that the mobile device may be configured as a base station for other wireless devices.

An audio subsystem 1226 can be coupled to a speaker 1228 and a microphone 1230 to facilitate voice-enabled functions, such as voice recognition, voice replication, digital recording, and telephony functions.

The I/O subsystem 1240 can include a touch screen controller 1242 and/or other input controller(s) 1244. The touch-screen controller 1242 can be coupled to a touch screen 1246. The touch screen 1246 and touch screen controller 1242 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen 1246.

The other input controller(s) 1244 can be coupled to other input/control devices 1248, such as one or more buttons, rocker switches, thumb-wheel, infrared port, USB port, and/or a pointer device such as a stylus. The one or more buttons (not shown) can include an up/down button for volume control of the speaker 1228 and/or the microphone 1230.

In one implementation, a pressing of the button for a first duration may disengage a lock of the touch screen 1246; and a pressing of the button for a second duration that is longer than the first duration may turn power to the mobile device on or off. The user may be able to customize a functionality of one or more of the buttons. The touch screen 1246 can, for example, also be used to implement virtual or soft buttons and/or a keyboard.

In some implementations, the mobile device can present recorded audio and/or video files, such as MP3, AAC, and MPEG files. In some implementations, the mobile device can include the functionality of an MP3 player, such as an iPod™. The mobile device may, therefore, include a 32-pin connector that is compatible with the iPod™. Other input/output and control devices can also be used.

The memory interface 1202 can be coupled to memory 1250. The memory 1250 can include high-speed random access memory and/or non-volatile memory, such as one or more magnetic disk storage devices, one or more optical storage devices, and/or flash memory (e.g., NAND, NOR). The memory 1250 can store an operating system 1252, such as Darwin, RTXC, LINUX, UNIX, OS X, WINDOWS, or an embedded operating system such as VxWorks. The operating system 1252 may include instructions for handling basic system services and for performing hardware dependent tasks. In some implementations, the operating system 1252 can be a kernel (e.g., UNIX kernel).

The memory 1250 may also store communication instructions 1254 to facilitate communicating with one or more additional devices, one or more computers and/or one or more servers. The memory 1250 may include graphical user interface instructions 1256 to facilitate graphic user interface processing; sensor processing instructions 1258 to facilitate sensor-related processing and functions; phone instructions 1260 to facilitate phone-related processes and functions; electronic messaging instructions 1262 to facilitate electronic-messaging related processes and functions; web browsing instructions 1264 to facilitate web browsing-related processes and functions; media processing instructions 1266 to facilitate media processing-related processes and functions; GPS/Navigation instructions 1268 to facilitate GPS and navigation-related processes and instructions; camera instructions 1270 to facilitate camera-related processes and functions; and/or other software instructions 1272 to facilitate other processes and functions, e.g., access control management functions. The memory 1250 may also store other software instructions (not shown), such as web video instructions to facilitate web video-related processes and functions; and/or web shopping instructions to facilitate web shopping-related processes and functions. In some implementations, the media processing instructions 1266 are divided into audio processing instructions and video processing instructions to facilitate audio processing-related processes and functions and video processing-related processes and functions, respectively. An activation record and International Mobile Equipment Identity (IMEI) 1274 or similar hardware identifier can also be stored in memory 1250.

Each of the above identified instructions and applications can correspond to a set of instructions for performing one or more functions described above. These instructions need not be implemented as separate software programs, procedures, or modules. The memory 1250 can include additional instructions or fewer instructions. Furthermore, various functions of the mobile device may be implemented in hardware and/or in software, including in one or more signal processing and/or application specific integrated circuits.

Those of skill may recognize that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

While the above detailed description has shown, described, and pointed out novel features of the invention as applied to various embodiments, it may be understood that various omissions, substitutions, and changes in the form and details of a device or process illustrated may be made by those skilled in the art without departing from the spirit of the invention. As may be recognized, the present invention may be embodied within a form that does not provide all of the features and benefits set forth herein, as some features may be used or practiced separately from others. The scope of the invention is indicated by the appended claims rather than by the foregoing description. All changes which come within the meaning and range of equivalency of the claims are to be embraced within their scope.

What may be claimed may be:

1. A computer-implemented method of provisioning a computing device in a mobile network, the method comprising:
receiving a provisioning profile comprising entitlement data indicative of allowed access to resources on a device;
receiving a request to provision a computing device; and
provisioning the computing device at least in part by delivering the provisioning profile to the device.

2. The method of claim 1, wherein an operating system of the computing device is configured to execute code only if signed by a trusted authority.

3. The method of claim 2, wherein the provisioning profile is generated by a trusted authority of the computing device.

4. The method of claim 2, wherein the provisioning profile is signed by the trusted authority.

5. The method of claim 2, wherein the trusted authority exercises control over the operating system security model of the computing device.

6. The method of claim 1, wherein the entitlement data comprises a blacklist of device resources to be restricted from access.

7. The method of claim 6, wherein the blacklist of device resources comprise at least one or more of application programming interfaces, protected data, and a hardware interface on the device.

8. The method of claim 1, wherein the provisioning profile comprises device identifier data indicative of a device identifier associated with the provisioning request.

9. The method of claim 1, wherein provisioning the computing device further comprises installing a policy service on the device.

10. The method of claim 1, wherein the provisioning profile further comprises identifier data indicative of entities authorized to sign code executed on the device.

11. A computer-readable medium having computer-executable instruction stored thereon, which when executed by a processor cause an activation service to perform a method of provisioning a computing device in a mobile network, the method comprising:
receiving a provisioning profile comprising entitlement data indicative of allowed access to resources on a device;
receiving a request to provision a computing device; and
provisioning the computing device at least in part by delivering the provisioning profile to the device.

12. The computer-readable medium of claim 11, wherein an operating system of the computing device is configured to execute code only if signed by a trusted authority.

13. The computer-readable medium of claim 12, wherein the provisioning profile is generated by a trusted authority of the computing device.

14. The computer-readable medium of claim 12, wherein the provisioning profile is signed by the trusted authority.

15. The computer-readable medium of claim 12, wherein the trusted authority exercises control over the operating system security model of the computing device.

16. The computer-readable medium of claim 11, wherein the entitlement data comprises a blacklist of device resources to be restricted from access.

17. The computer-readable medium of claim 16, wherein the blacklist of device resources comprise at least one or more of application programming interfaces, protected data, and a hardware interface on the device.

18. The computer-readable medium of claim 11, wherein the provisioning profile comprises device identifier data indicative of a device identifier associated with the provisioning request.

19. The computer-readable medium of claim 11, wherein provisioning the computing device further comprises installing a policy service on the device.

20. The computer-readable medium of claim 11, wherein the provisioning profile further comprises identifier data indicative of entities authorized to sign code executed on the device.

21. A carrier provisioning profile stored on a server in a network, said profile comprising:
device identifier data comprising data indicative of at least one device covered by the profile;
identifier data comprising data indicative of at least one entity authorized to digitally sign code executed on the device; and
entitlement data comprising data indicative of carrier policies for device operation on a carrier network.

22. The carrier provisioning profile of claim 21, wherein the data indicative of carrier policies comprises a blacklist of device-capable functions not available to device users on the carrier network.

23. The carrier provisioning profile of claim 22, wherein the device identifier data comprises a serial number related to the at least one device covered by the profile.

24. The carrier provisioning profile of claim 21, wherein the profile is digitally signed by a trusted authority of the at least one device covered by the profile.

25. A mobile telephone device comprising:
a provisioning profile that is specific to a carrier and the device comprising:
device identifier data comprising data indicative of at least one device covered by the profile;
entity identifier data comprising data indicative of at least one entity authorized to digitally sign code executed on the device; and
entitlement data comprising data indicative of carrier policies for device operation on a carrier network.

26. The mobile telephone device of claim 25, further comprising a policy service configured to enforce the carrier policies indicated by the entitlement data.

27. The mobile telephone device of claim 26, wherein the policy service is configured to prevent the execution of trusted code based on the carrier policies indicated by the entitlement data.
